(19) United States
(12) Patent Application Publication
(10) Pub. No.: US 2016/0093967 A1
(43) Pub. Date: Mar. 31, 2016

(54) CONNECTOR

(71) Applicants: JAPAN AVIATION ELECTRONICS INDUSTRY, LIMITED, Tokyo (JP); JAE ELECTRONICS, INC., Irvine, CA (US)

(72) Inventors: Yuichi TAKENAGA, Tokyo (JP); Hiroaki OBIKANE, Tokyo (JP); Takayuki NISHIMURA, Tokyo (JP); Daisuke MACHIHARA, Irvine, CA (US); Yutaro MORI, Tokyo (JP)

(73) Assignees: JAE ELECTRONICS, INC., Irvine, CA (US); JAPAN AVIATION ELECTRONICS INDUSTRY, LIMITED, Tokyo (JP)

(21) Appl. No.: 14/734,433

(22) Filed: Jun. 9, 2015

Related U.S. Application Data
(60) Provisional application No. 62/055,996, filed on Sep. 26, 2014.

(51) Int. Cl. H01R 12/71

(52) U.S. Cl. CPC H01R 12/716

(57) ABSTRACT

Disclosed is a connector mateable with a mating connector along a first direction. The connector comprises a housing and a plurality of terminals, wherein the housing includes a plurality of held portions, and the terminals correspond to the held portions, respectively. Each of the terminals includes a base portion, a first portion, a second portion and a third portion. The first portion extends directly from the base portion and is provided with a first contact portion which projects towards the second portion in a second direction perpendicular to the first direction. The second portion extends directly from the base portion and is provided with a second contact portion and a press-fitting projection. The second contact portion projects towards the first portion in the second direction and faces the first contact portion. The press-fitting projection projects towards the third portion in the second direction. The third portion extends directly from the base portion. Each of the held portions is held by the second portion and the third portion of the terminal corresponding thereto.

### CROSS REFERENCE TO RELATED APPLICATIONS

This application claims the benefit of U.S. Provisional Application No. 62/055,996 filed Sep. 26, 2014, the contents of which are herein incorporated by reference in its entirety.

### BACKGROUND OF THE INVENTION

This invention relates to a connector which is to be mounted on a circuit board and is mateable with a mating connector mounted on a mating circuit board.

As shown in FIG. 27, Patent Document 1 discloses a connector 900 and a mating connector 950 which are mounted on a circuit board 910 and a mating circuit board 960, respectively. The connector 900 comprises a housing 920 made of insulator and a plurality of terminals 930 each made of conductor. The housing 920 is formed of press-fit holes 925. The terminals 930 are provided with press-fitting portions 935, respectively. The press-fitting portions 935 are press-fit into the press-fit holes 925, respectively, so that the terminals 930 are held by the housing 920. In order to prevent the housing 920 from being broken upon the press-fitting of the press-fitting portions 935 into the press-fit holes 925, the housing 920 has thicker thickness to secure a certain strength. The mating connector 950 comprises a mating housing 970 made of insulator and a plurality of mating terminals 980 each made of conductor. The mating terminals 980 are held by the mating housing 970.

[Patent Document 1] JP 2006-302901 A, FIG. 2

### SUMMARY OF THE INVENTION

It is an object of the present invention to provide a connector which is more downsized.

One aspect of the present invention provides a connector which is mateable with a mating connector along a first direction. The connector comprises a housing and a plurality of terminals, wherein the housing includes a plurality of held portions, and the terminals correspond to the held portions, respectively. Each of the terminals includes a base portion, a first portion, a second portion and a third portion. The first portion extends directly from the base portion and is provided with a first contact portion which projects towards the second portion in a second direction perpendicular to the first direction. The second portion extends directly from the base portion and is provided with a second contact portion and a press-fitting projection. The second contact portion projects towards the first portion in the second direction and faces the first contact portion. The press-fitting projection projects towards the third portion in the second direction. The third portion extends directly from the base portion. Each of the held portions is held by the second portion and the third portion of the terminal corresponding thereto.

Each of the terminals has no portion press-fit into the housing. Instead, the housing is provided with the held portions, each of which is inserted between the second portion and the third portion of the terminal corresponding thereto, so as to be held by the second portion and the third portion. Therefore, the housing is not required to have thickness same as that of the connector of Patent Document 1. The housing can be downsized, and accordingly, the connector can be downsized.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a top oblique view showing a connector in accordance with a first embodiment of the present invention.

FIG. 2 is a bottom oblique view showing the connector of FIG. 1.

FIG. 3 is a top plan view showing the connector of FIG. 1.

FIG. 4 is a cross-sectional view showing the connector of FIG. 3, taken along line A-A.

FIG. 5 is a cross-sectional view showing the connector of FIG. 3, taken along line B-B.

FIG. 6 is a cross-sectional view showing the connector of FIG. 3, taken along line C-C.

FIG. 7 is an enlarged view showing a part of the connector of FIG. 2, encircled by circle D.

FIG. 8 is an enlarged view showing a part of the connector of FIG. 4, encircled by circle E.

FIG. 9 is a top oblique view showing a housing included in the connector of FIG. 1.

FIG. 10 is a bottom oblique view showing the housing of FIG. 9.

FIG. 11 is a cross-sectional view showing the housing of FIG. 9, taken along line F-F.

FIG. 12 is an oblique view showing a terminal included in the connector of FIG. 1.

FIG. 13 is an oblique view showing a reinforcement member included in the connector of FIG. 1.

FIG. 14 is a side view showing the reinforcement member of FIG. 13.

FIG. 15 is a cross-sectional view showing a mating connector.

FIG. 16 is a view showing a state where the connector of FIG. 4 is mated with the mating connector of FIG. 15.

FIG. 17 is a top oblique view showing a connector in accordance with a second embodiment of the present invention.

FIG. 18 is a bottom oblique view showing the connector of FIG. 17.

FIG. 19 is a top plan view showing the connector of FIG. 17.

FIG. 20 is a cross-sectional view showing the connector of FIG. 19, taken along line G-G.

FIG. 21 is a cross-sectional view showing the connector of FIG. 19, taken along line H-H.

FIG. 22 is a cross-sectional view showing the connector of FIG. 19, taken along line J-J.

FIG. 23 is an enlarged view showing a part of the connector of FIG. 17, encircled by circle K.

FIG. 24 is a top oblique view showing a housing included in the connector of FIG. 17.

FIG. 25 is an enlarged view showing a part of the housing of FIG. 24, encircled by circle L.

FIG. 26 is an oblique view showing a reinforcement member included in the connector of FIG. 17.

FIG. 27 is a view showing a connector and a mating connector of Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

### First Embodiment

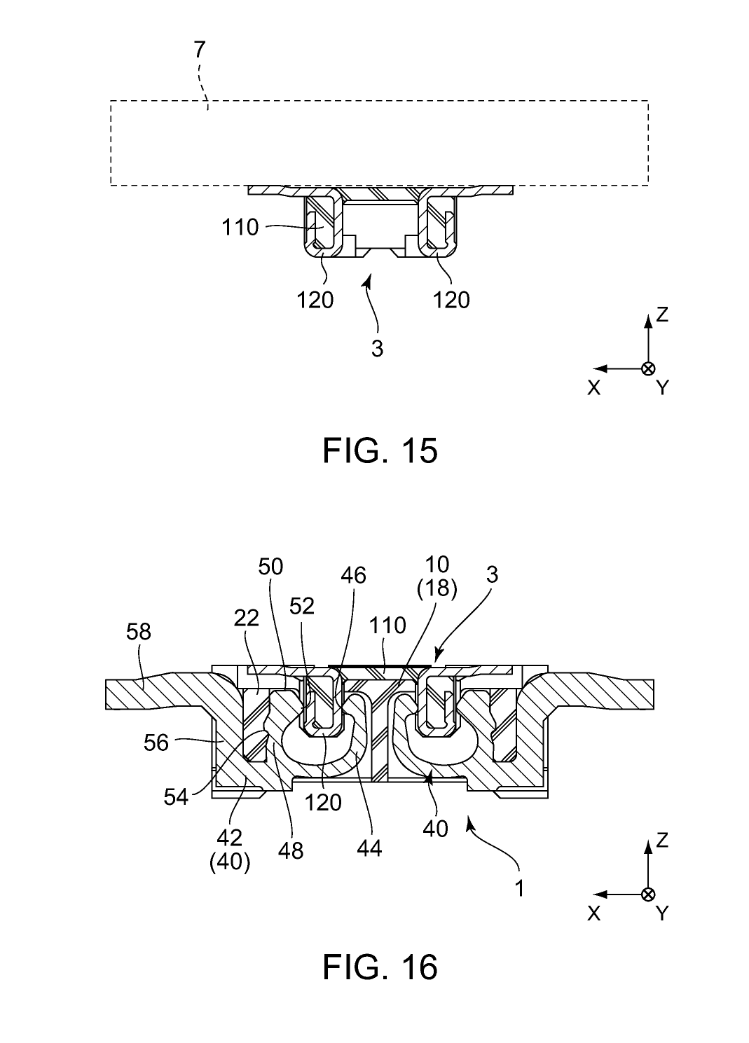

With reference to FIG. 4, a connector 1 according to a first embodiment of the present invention is to be mounted and fixed to a circuit board 5. Specifically, the circuit board 5 of the present embodiment is formed with a hollow portion 6. When mounted to the circuit board 5, the connector 1 is partially accommodated within the hollow portion 6. As understood from FIGS. 4, 15 and 16, the connector 1 is to be mated with a mating connector 3 along a Z-direction (first direction). As shown in FIG. 15, the mating connector 3 is to be mounted and fixed to a mating circuit board 7. As understood from the above, the connector 1 and the mating connector 3 constitute a board-to-board connector assembly. As shown in FIG. 15, the mating connector 3 comprises a mating housing 110 and a plurality of mating terminals 120. The mating terminals 120 are held by the mating housing 110.

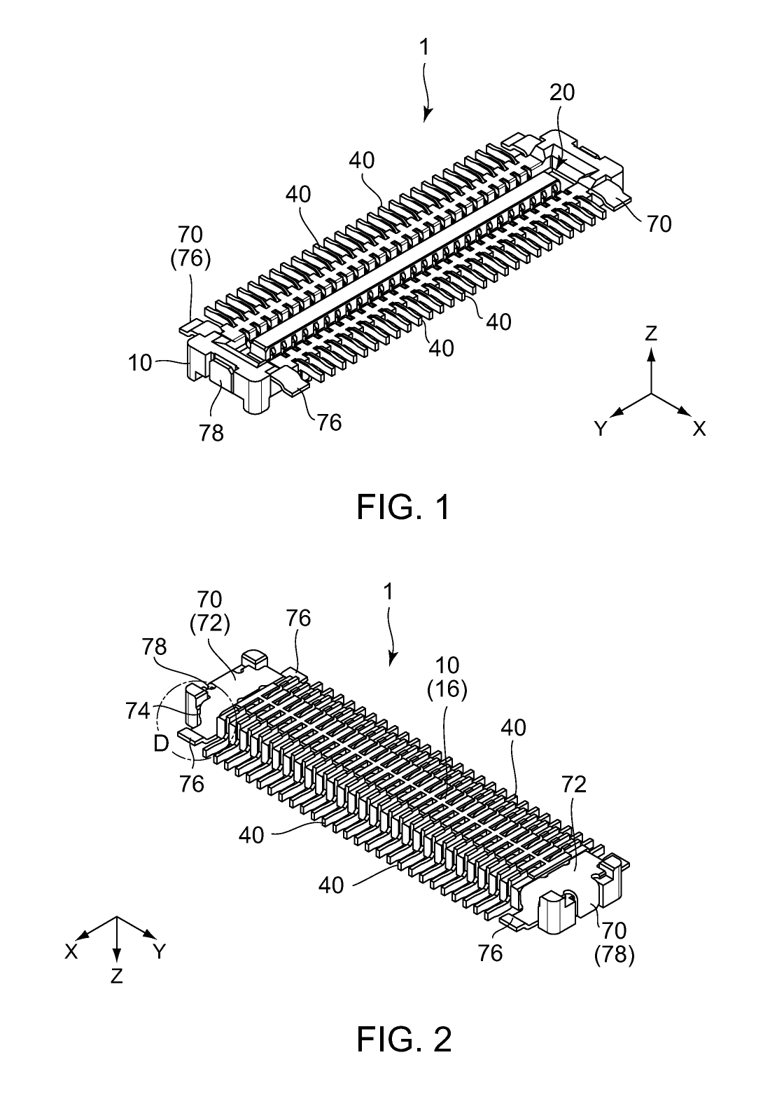

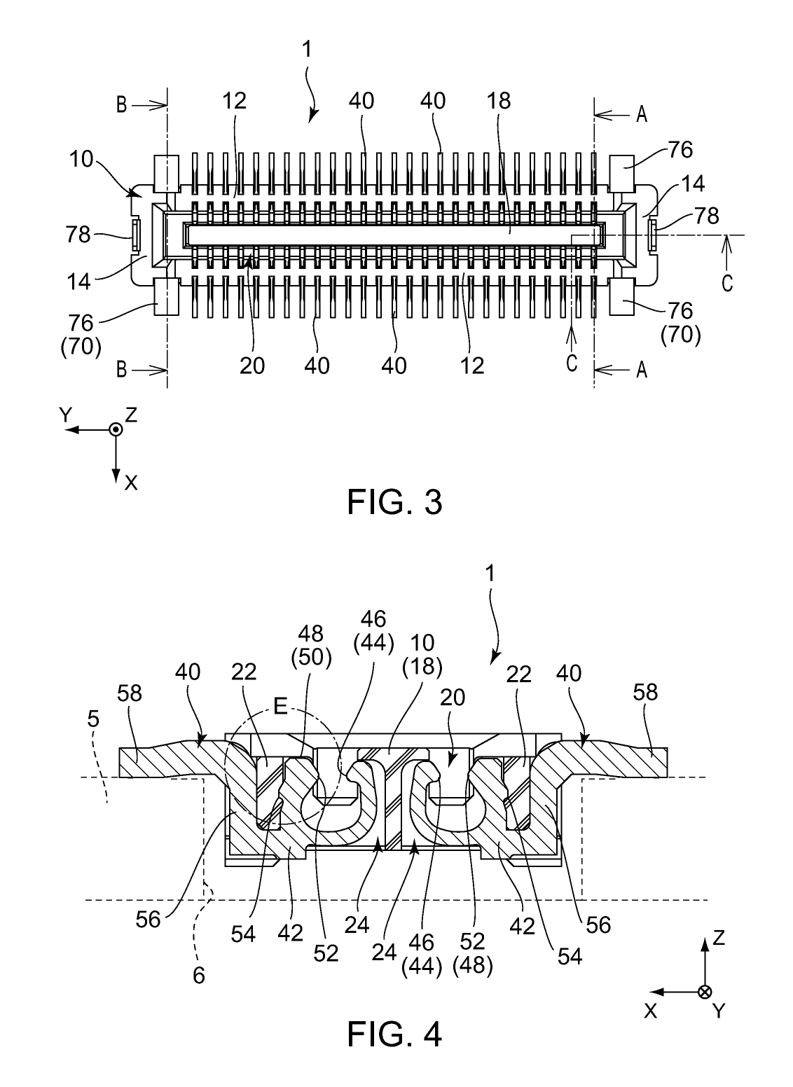

With reference to FIGS. 1 to 3, the connector 1 comprises a housing 10 made of insulator, a plurality of terminals 40 each made of conductor and two reinforcement members 70 each made of metal.

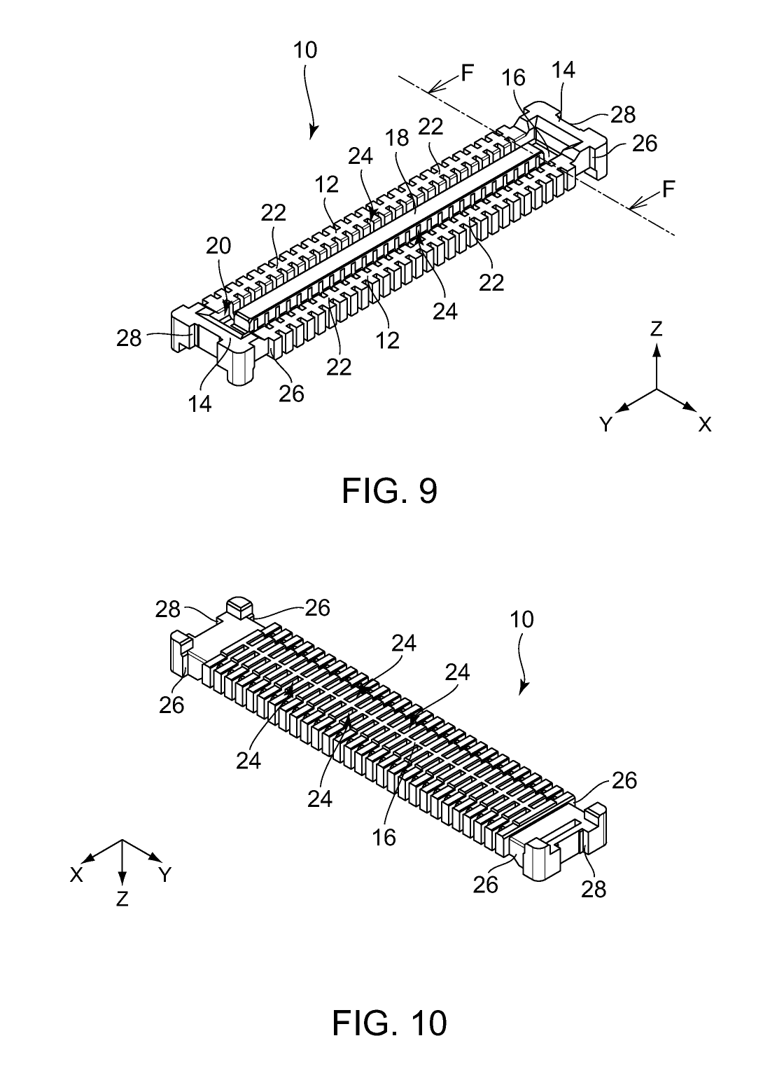

As shown in FIG. 9, the housing 10 includes two first wall portions 12, two second wall portions 14, a bottom portion 16 and an island portion 18. The first wall portions 12 are positioned away from each other in an X-direction (second direction). Each of the first wall portions 12 extends long in a Y-direction (third direction). Each first wall portion 12 is provided with a plurality of held portions 22. As understood from FIGS. 1, 4 and 9, the held portions 22 correspond to the terminals 40, respectively. As shown in FIG. 9, the second wall portions 14 are positioned away from each other in the Y-direction. Each of the second wall portions 14 connects the first wall portions 12 in the X-direction. The island portion 18 protrudes from the bottom portion 16 in the Z-direction. The island portion 18 extends long in the Y-direction. Between the island portion 18 and the first wall portions 12 as well as the second wall portions 14, a receiving portion 20 is formed. Each of the first wall portions 12 of the present embodiment has a length of about 12 mm in the Y-direction and has a thickness of about 0.2 mm in the X-direction. As apparent from the above, the connector 1 is extremely small.

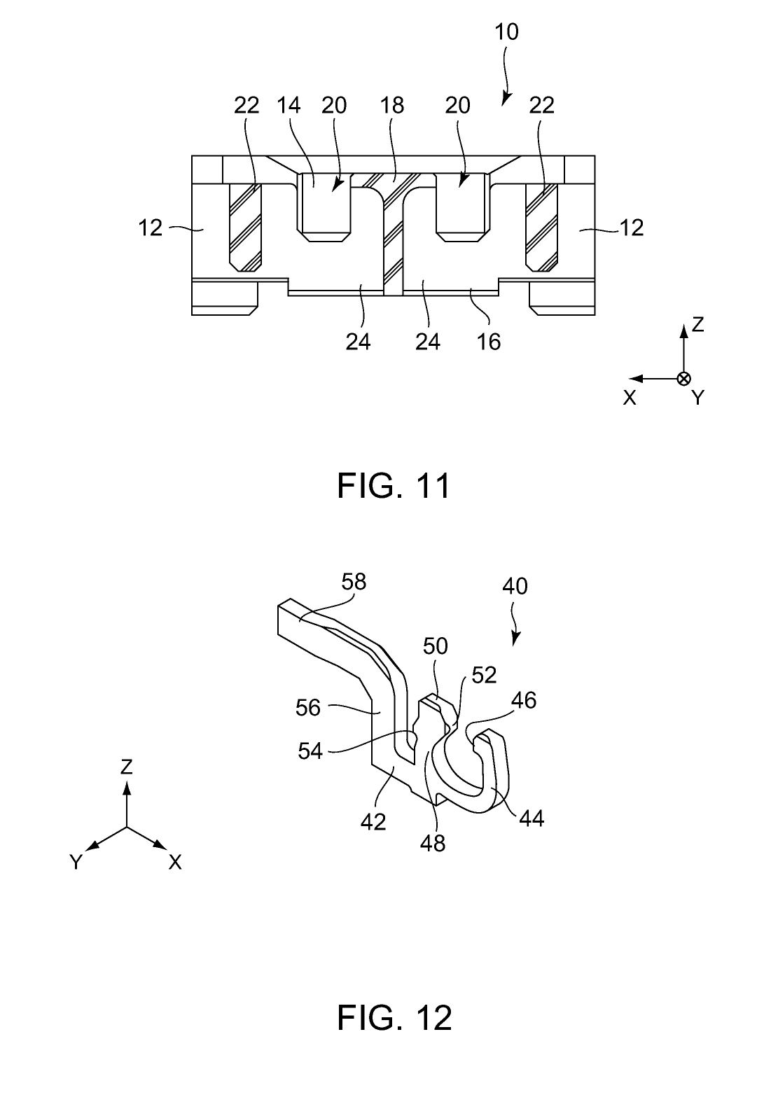

As shown in FIGS. 9 to 11, the housing 10 is formed with a plurality of terminal accommodation portions 24. As understood from FIGS. 1, 4, 9 and 11, the terminal accommodation portions 24 correspond to the terminals 40, respectively. As shown in FIGS. 9 and 10, the terminal accommodation portions 24 pierce the bottom portion 16 and communicate with the receiving portion 20. As shown in FIGS. 9 to 11, each terminal accommodation portion 24 is partially formed in the first wall portion 12 and the island portion 18, too. As shown in FIG. 11, the held portions 22 of the present embodiment are positioned within the terminal accommodation portions 24.

As shown in FIGS. 9 and 10, each first wall portion 12 is formed with two press-fit portions 26. Each press-fit portion 26 is positioned at one end of the first wall portion 12 in the Y-direction and is depressed inwards in the X-direction. Each second wall portion 14 is formed with a depressed portion 28. The depressed portion 28 is depressed inwards in the Y-direction.

As shown in FIG. 16, the terminals 40 correspond to the mating terminals 120, respectively. As shown in FIG. 4, the terminals 40 are partially accommodated within the terminal accommodation portions 24, respectively.

As shown in FIG. 12, each terminal 40 is formed by stamping a metal plate but is not formed by bending or folding. In other words, the terminal 40 is a stamped member. As shown in FIGS. 4 and 12, each terminal 40 includes a base portion 42, a first portion 44, a second portion 48, a third portion 56 and a fixed portion 58. In detail, FIG. 12 shows one of the two terminals 40 shown in FIG. 4, which is positioned towards the positive X-side. The two terminals 40 shown in FIG. 4 have structures same as each other and are arranged in linear symmetry.

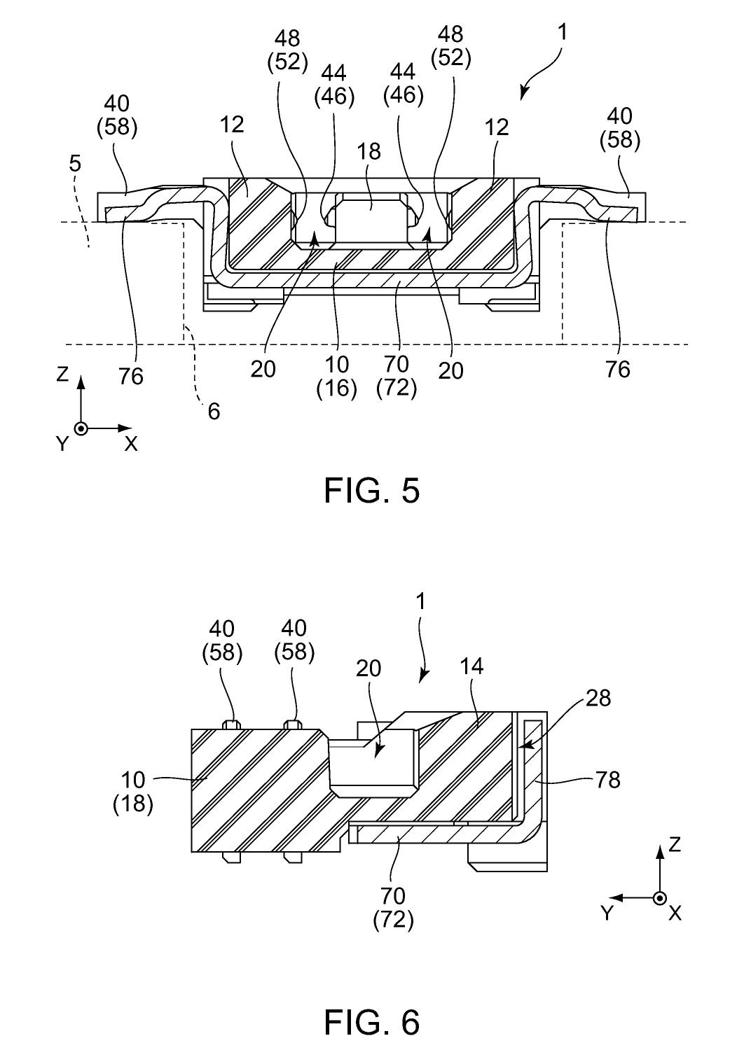

As shown in FIGS. 4 and 12, the first portion 44 has an L-like shape and is resiliently deformable. The first portion 44 extends directly from the base portion 42 inwards in the X-direction. The first portion 44 is provided with a first contact portion 46 which projects towards the second portion 48 in the X-direction. As shown in FIGS. 4 and 5, when the connector 1 is not mated with the mating connector 3, the first contact portion 46 projects within the receiving portion 20.

As shown in FIGS. 4 and 12, the second portion 48 extends directly from the base portion 42 in the Z-direction. The second portion 48 is provided with a second contact portion 52 and a press-fitting projection 54. In the Z-direction, a distance between an end portion 50 and the base portion 42 is larger than another distance between the press-fitting projection 54 and the base portion 42. In other words, in the Z-direction, the press-fitting projection 54 is positioned between the end portion 50 of the second portion 48 and the base portion 42. The second contact portion 52 projects towards the first portion 44 in the X-direction. In particular, as shown in FIGS. 4 and 5, the second contact portion 52 of the present embodiment projects within the receiving portion 20 when the connector 1 is not mated with the mating connector 3. Furthermore, as shown in FIGS. 4 and 12, the second contact portion 52 faces the first contact portion 46 in the X-direction. In other words, as shown in FIG. 4, nothing exists between the first contact portion 46 and the second contact portion 52 in the X-direction when the connector 1 is not mated with the mating connector 3. As shown in FIGS. 4 and 12, the press-fitting projection 54 projects towards the third portion 56 in the X-direction.

As shown in FIGS. 4 and 12, the third portion 56 extends directly from the base portion 42 in the Z-direction. The second portion 48 and the third portion 56 are positioned away from each other in the X-direction. As understood from FIGS. 4, 11 and 12, each held portion 22 is inserted between the second portion 48 and the third portion 56 of the terminal 40 corresponding to the held portion 22, so as to be caught and held by the second portion 48 and the third portion 56. As best shown in FIG. 8, the end portion 50 of the second portion 48 of the present embodiment is positioned away from the held portion 22 in the X-direction.

As shown in FIG. 4, the fixed portion 58 is fixed to the circuit board 5, for example, by soldering when the connector 1 is mounted to the circuit board 5. As shown in FIGS. 4 and 12, the fixed portion 58 extends from the third portion 56 outwards in the X-direction. The fixed portion 58 is positioned away from the base portion 42 in the Z-direction. Therefore, as shown in FIG. 4, the connector 1 can be fixed to the circuit board 5 while the connector 1 is partially accommodated in the hollow portion 6 of the circuit board 5.

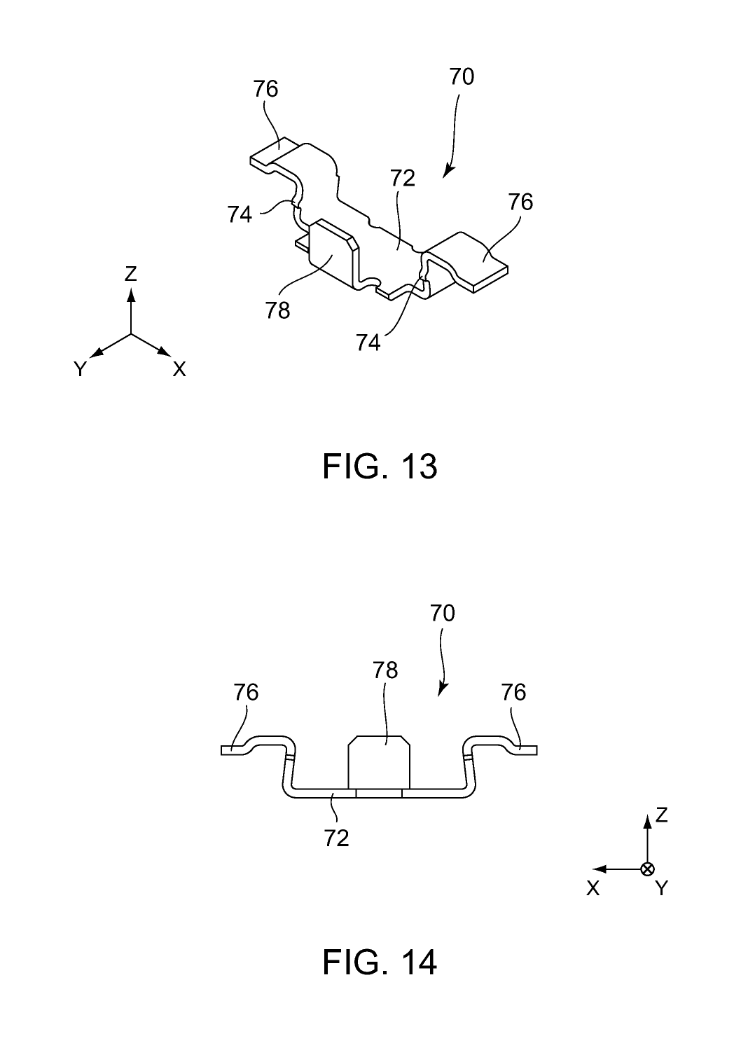

As shown in FIGS. 13 and 14, each reinforcement member 70 includes a support portion 72, two securing portions 76 and one reinforcement piece 78. In detail, FIGS. 13 and 14 show one of the two reinforcement members 70 shown in FIG. 1, which is positioned towards the positive Y-side. The two reinforcement members 70 shown in FIG. 1 have structures same as each other and are arranged in linear symmetry.

As shown in FIGS. 13 and 14, the support portion 72 has a wide, angular-U shape. The support portion 72 is provided with press-fitting portions 74 projecting in the Y-direction. The securing portions 76 extend from the support portion 72 in directions opposite to each other in the X-direction. The reinforcement piece 78 extends from the support portion 72 in the Z-direction.

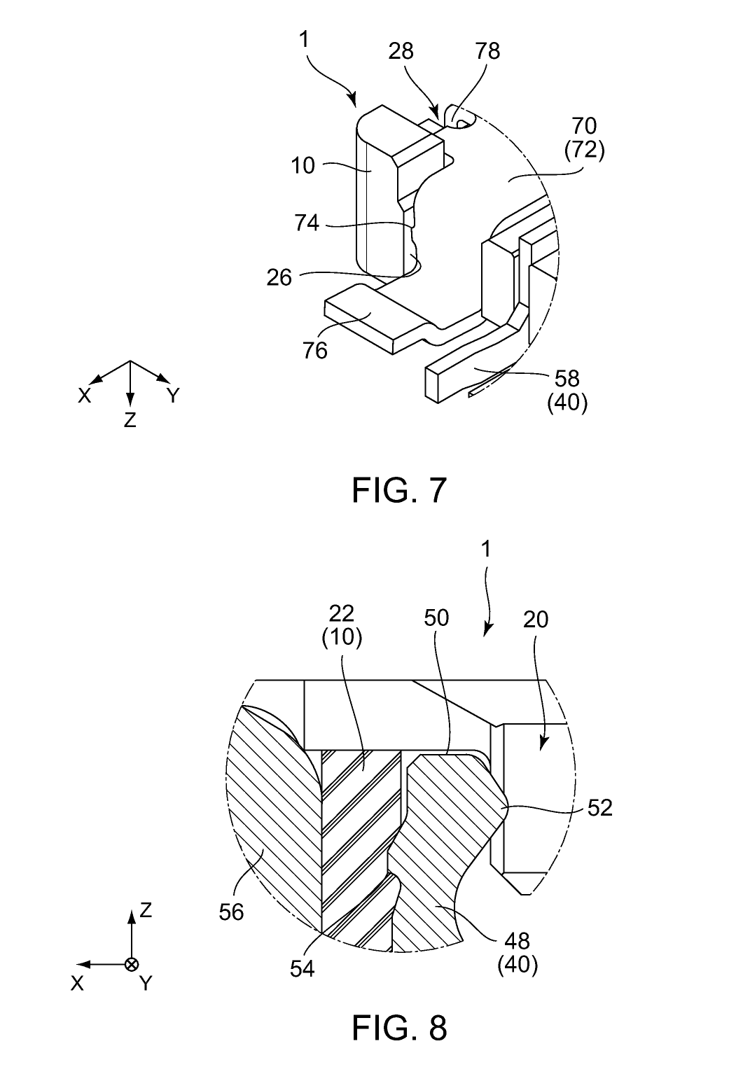

As shown in FIGS. 1 and 2, the reinforcement members 70 are attached to the housing 10. As understood from FIGS. 2, 7 and 10, the press-fitting portions 74 are press-fit into the press-fit portions 26 and are held by the press-fit portions 26. As show in FIG. 5, the support portions 72 thus surround a part of the bottom portion 16 and parts of the first wall portions 12 of the housing 10 from outside thereof. As understood from FIGS. 1, 6 and 9, the reinforcement pieces 78 are received within the depressed portions 28. As shown in FIG. 6, the reinforcement pieces 78 are positioned close to and outside of the second wall portions 14 and reinforce the second wall portions 14, respectively. When the connector 1 is mated with the mating connector 3 (see FIG. 5), a part of the mating connector 3 might be in abutment with the second wall portion 14 to press the second wall portion 14 outwards in the Y-direction. Even in such case, since the reinforcement piece 78 reinforces the second wall portion 14, the second wall portion 14 can be prevented from being damaged.

As shown in FIG. 5, the securing portions 76 are fixed to the circuit board 5 when the connector 1 is mounted to the circuit board 5, so as to secure the support portion 72 to the circuit board 5. As shown in FIGS. 4 and 5, the connector 1 is disposed within the hollow portion 6 of the circuit board 5. Therefore, the circuit board 5 as such cannot support the connector 1 when the connector 1 is mated with the mating connector 3 (see FIG. 5). Instead, as understood from FIG. 5, the support portion 72 receives and supports the housing 10 when the connector 1 is mated with the mating connector 3.

As shown in FIG. 16, when the connector 1 is mated with the mating connector 3, each of the mating terminals 120 is interposed between the first contact portion 46 and the second contact portion 52 of the terminal 40 corresponding to the mating terminal 120, so that the press-fitting projection 54 is pressed against the held portion 22. As shown in FIG. 8, the end portion 50 of the present embodiment is positioned away from the held portion 22 in the X-direction before the connector 1 is mated with the mating connector 3. As shown in FIG. 16, when the connector 1 is mated with the mating connector 3, the end portion 50 is moved towards the held portion 22. Especially in the present embodiment, the end portion 50 is in contact with the held portion 22 when the connector 1 is mated with the mating connector 3. Accordingly, the press-fitting projection 54 is pressed against the held portion 22 more strongly so that the holding of the housing 10 by the terminal 40 is reinforced. Therefore, the housing 10 can be prevented from coming off the terminal 40 when the connector 1 is detached from the mating connector 3.

### Second Embodiment

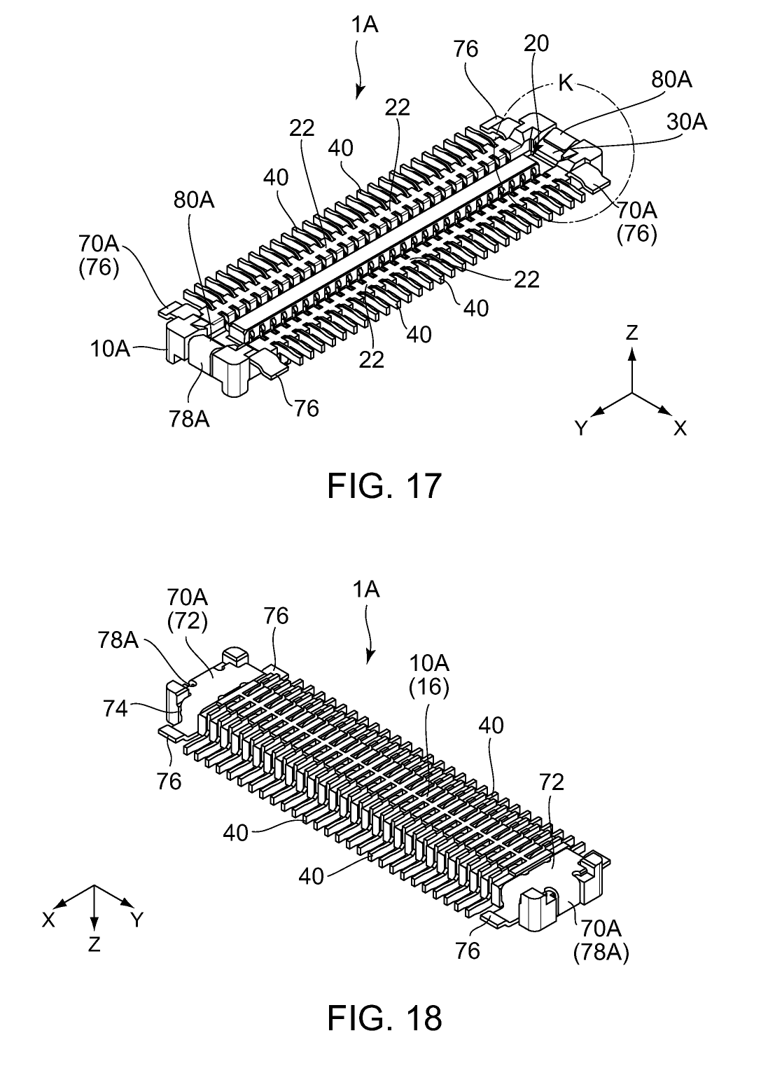

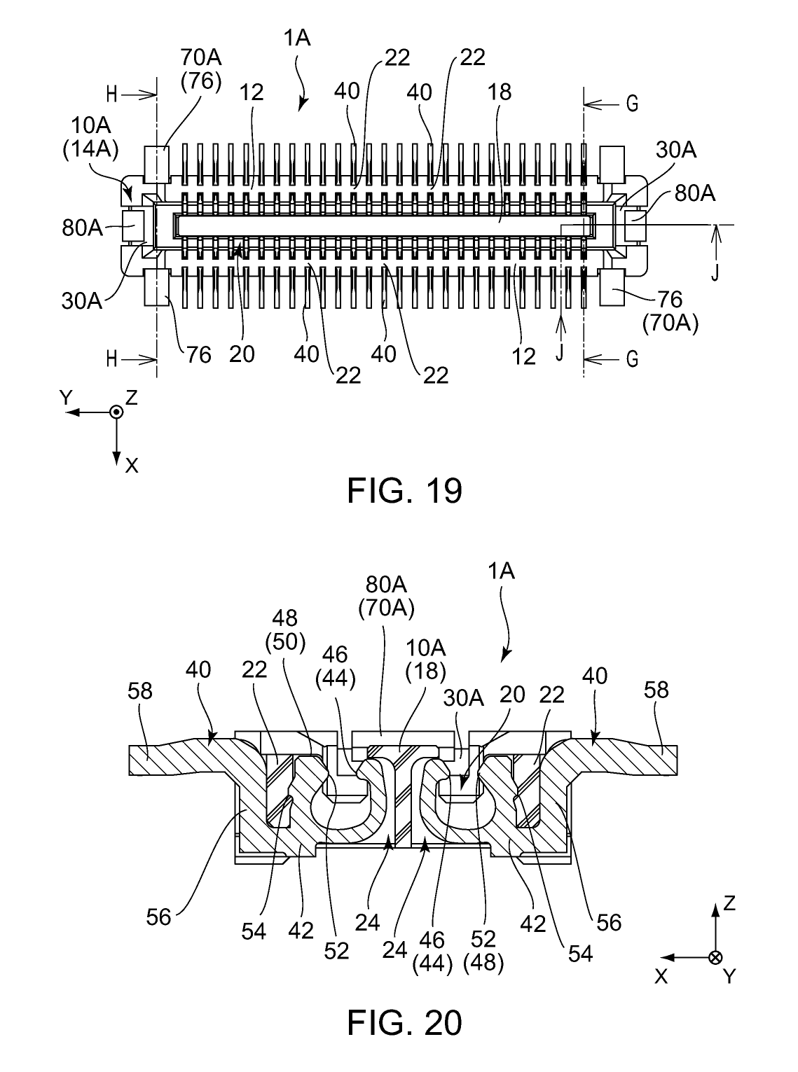

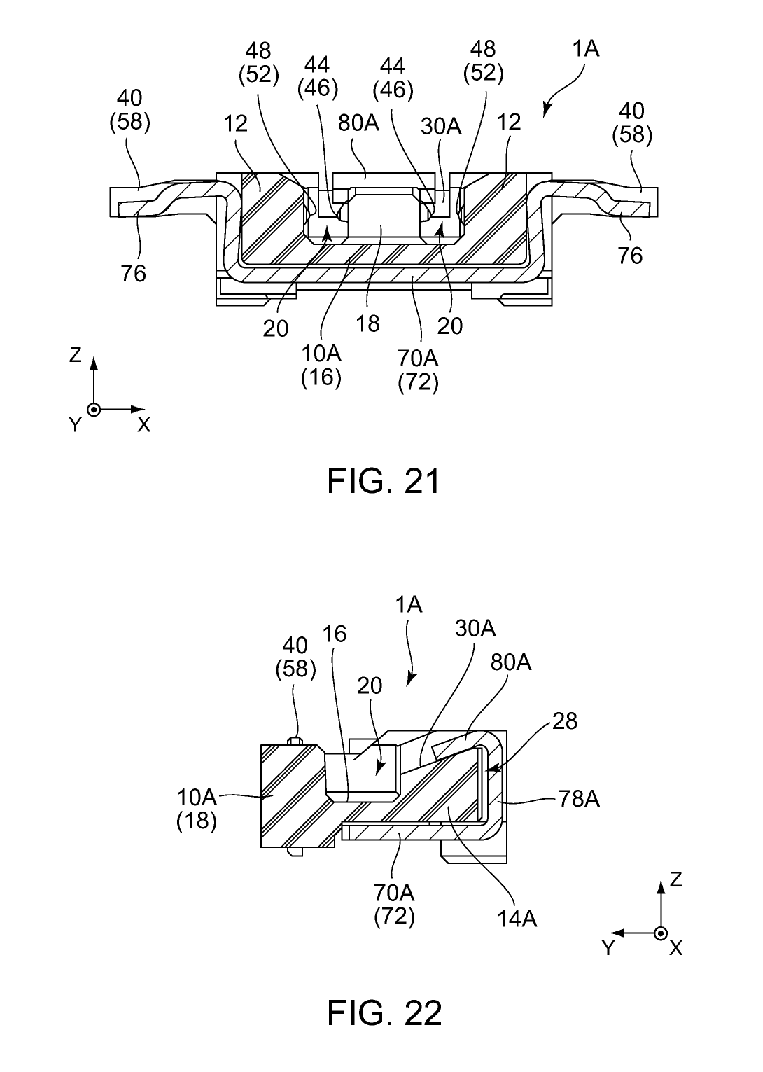

With reference to FIGS. 1 to 6 as well as FIGS. 17 to 22, a connector 1A according to a second embodiment of the present invention is a modification of the connector 1 of the above-mentioned first embodiment. The connector 1A is different from the connector 1 only in structures of reinforcement members 70A and parts therearound. In FIGS. 17 to 26, components same as the components already described with FIGS. 1 to 16 are depicted with reference numerals same as those of the same components; explanation about those components will be omitted. For example, the terminals 40 of the connector 1A are same as the terminals 40 of the aforementioned first embodiment. Likewise, a structural relation between a housing 10A and the terminals 40 of the connector 1A is same as a structural relation between the housing 10 and the terminals 40 of the aforementioned connector 1.

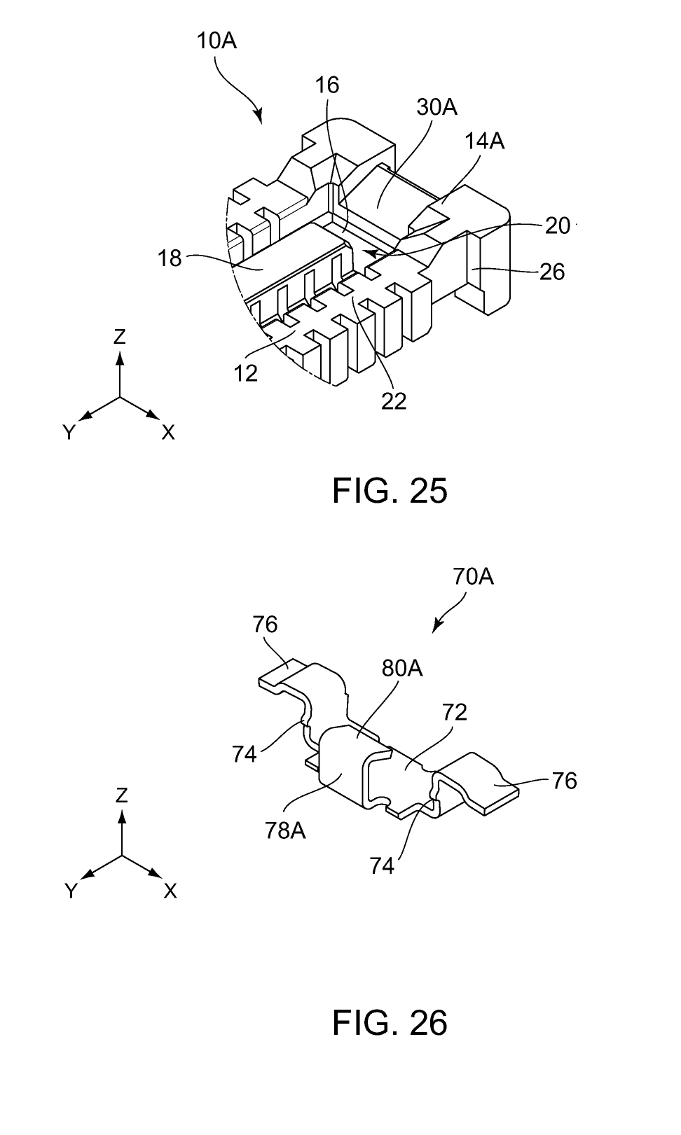

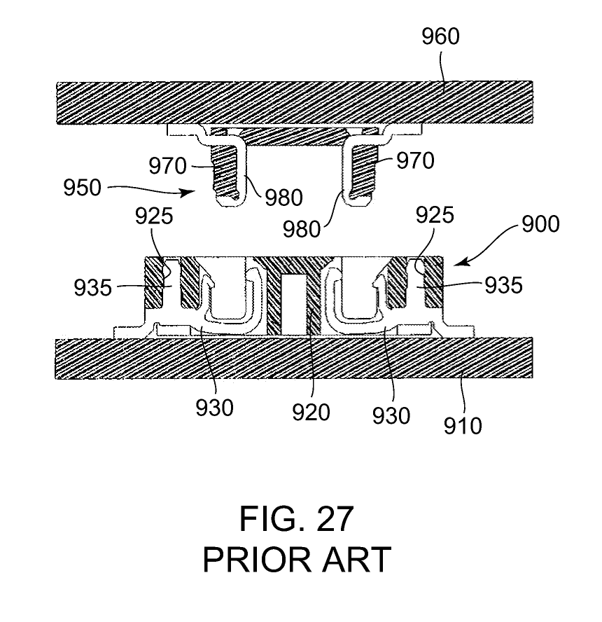

As shown in FIGS. 24 and 25, second wall portions 14A of the housing 10A of the present embodiment are formed with retained portions 30A, respectively. Each of the retained portions 30A of the present embodiment is depressed in the Z-direction and has a slope extending towards the bottom portion 16.

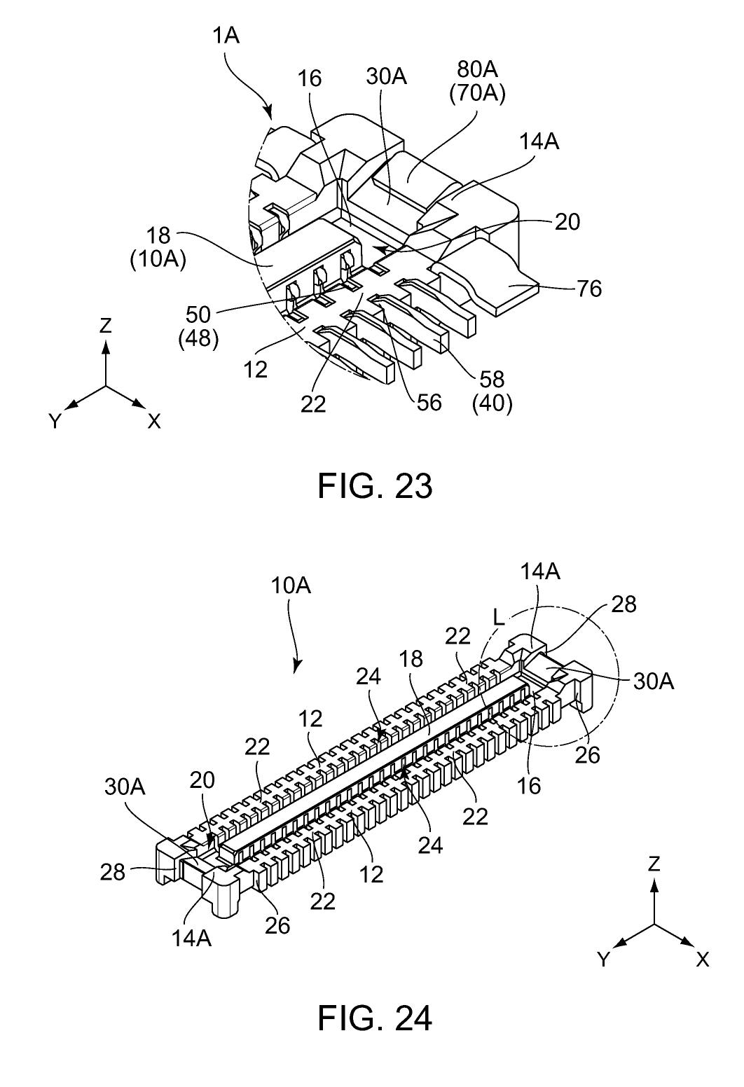

As shown in FIGS. 17 and 26, each reinforcement member 70A is further provided with a retaining portion 80A which extends from a reinforcement piece 78A along a direction oblique to both the Y-direction and the Z-direction. As shown in FIG. 17, when the reinforcement members 70A are attached to the housing 10A, the retaining portions 80A project towards each other in the Y-direction. As best shown in FIG. 22, each retaining portion 80A is positioned away from the support portion 72 in the Z-direction. As shown in FIGS. 22 and 23, the retaining portion 80A extends along the retained portion 30A towards the bottom portion 16. As shown in FIG. 22, the retained portion 30A of the second wall portion 14A is positioned between the retaining portion 80A and the support portion 72. Therefore, it can be prevented that, when the connector 1 is detached from the mating connector 3, the housing 10A follows up the mating connector 3 so as to come off the reinforcement member 70A.

The connectors 1, 1A according to the aforementioned embodiments can be modified variously. For example, although each of the housings 10, 10A according to the aforementioned embodiments is provided with the depressed portions 28, the depressed portions 28 may not be provided. In addition, the retained portions 30A may have surfaces perpendicular to the Z-direction, instead of the slopes.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector mateable with a mating connector along a first direction, comprising:
a housing including a plurality of held portions; and
a plurality of terminals corresponding to the held portions, respectively, wherein: each of the terminals includes a base portion, a first portion, a second portion and a third portion; the first portion extends directly from the base portion and is provided with a first contact portion which projects towards the second portion in a second direction perpendicular to the first direction; the second portion extends directly from the base portion and is provided with a second contact portion and a press-fitting projection; the second contact portion projects towards the first portion in the second direction and faces the first contact portion; the press-fitting projection projects towards the third portion in the second direction; the third portion extends directly from the base portion; and each of the held portions is held by the second portion and the third portion of the terminal corresponding thereto.

2. The connector as recited in claim 1, wherein:
the mating connector includes a plurality of mating terminals which correspond to the terminals, respectively; and
when the connector is mated with the mating connector, each of the mating terminals is caught between the first contact portion and the second contact portion of the terminal corresponding thereto so that the press-fitting projection is pressed against the held portion.

3. The connector as recited in claim 2, wherein:
the second portion has an end portion;
in the first direction, a distance between the end portion and the base portion is greater than another distance between the press-fitting projection and the base portion;
before the connector is mated with the mating connector, the end portion is located away from the held portion in the second direction; and
when the connector is mated with the mating connector, the end portion is moved to or towards the held portion.

4. The connector as recited in claim 1, wherein:
each of the terminals is provided with a fixed portion which is fixed to a circuit board when the connector is mounted to the circuit board; and
the fixed portion extends from the third portion and is located away from the base portion in the first direction.

5. The connector as recited in claim 4, further comprising two reinforcement members attached to the housing, wherein:
each of the reinforcement members includes a support portion and two securing portions;
the support portion receives and supports the housing upon the mating of the connector with the mating connector;
the securing portions extend oppositely to each other from the support portion in the second direction; and
the securing portions are fixed on the circuit board to secure the support portion to the circuit board when the connector is mounted to the circuit board.

6. The connector as recited in claim 5, wherein:
the housing has two first wall portions and two second wall portions;
the first wall portions are located away from each other in the second direction;
each of the first wall portions includes the held portions;
the second wall portions are located away from each other in a third direction perpendicular to both the first direction and the second direction;
each of the second wall portions connects the first wall portions in the second direction;
the reinforcement members are further provided with reinforcement pieces, respectively; and
the reinforcement pieces extend from the support portions in the first direction and are positioned outside and close to the second wall portions in the third direction to reinforce the second wall portions, respectively.

7. The connector as recited in claim 6, wherein:
the reinforcement members are further provided with retaining portions, respectively, which project from the reinforce pieces towards each other in the third direction;
the retaining portions are located away from the support portions in the first direction; and
the second wall portions are located between the retaining portions and the support portions.
